(19) United States
(12) Patent Application Publication
(10) Pub. No.: US 2001/0035080 A1
(43) Pub. Date: Nov. 1, 2001

(54) Hand tool for holding a lawn mower blade

(76) Inventor: Gary L. Adams, Orlando, FL (US)

Correspondence Address: William M. Hobby, III, 157 E. New England Avenue, #375, Winter Park, FL, 32789, US

(21) Appl. No.: 09/818,357

(22) Filed: Mar. 27, 2001

Related U.S. Application Data
(60) Provisional application No. 60/192,466, filed on Mar. 27, 2000.

(51) Int. Cl. B25B 1/00

(52) U.S. Cl. 81/488

(57) ABSTRACT

The tool apparatus for holding a lawn mower blade for installation and removal of the blade has an elongated lever arm having a handle on the end thereof. A gripping portion is formed on the other end of the elongated lever arm blade engaging yoke formed thereon with a pair of spaced arms having a space therebetween. Each yoke arm has a blade engaging member extending perpendicular therefrom and each blade engaging member has a lip on the end thereof for engaging one side of the lawn mower blade over the lawn mower blade attaching nut. Each gripping portion has a third blade engaging member extending perpendicular therefrom and spaced from the pair of blade engaging members for engaging the other side of the lawn mower blade so that a lawn mower blade can be held by the tool over the lawn mower blade attaching nut for removing the attaching nut with a wrench.

### BACKGROUND OF THE INVENTION

A hand tool for holding a lawn mower blade is used to assist in the removal and replacement of lawn mower blades to prevent rotation of the blade while removing the lawn mower blade removal nut holding the blade to the blade shaft.

For peak efficiency, lawn mower blades should be resharpened or replaced regularly. Removing a blade retaining nut, which has been overtightened or rusted in place, can be difficult and even dangerous. It is necessary to lock the blade in place against rotation so that the high torque necessary to loosen the nut, can be applied with a long wrench. In the past, it has been common to use a block of wood or a brick or other handy object to place between the blade and the discharge chute of a rotary lawn mower. This has worked satisfactory at times but the haphazard nature of the holding object can result in the holding block slipping and the blade rotating to cut or bruise a person's hand while in the process of changing the blade. It has also been common to use a heavy glove but this frequently does not provide sufficient leverage during loosening of the nut. The problem is made more difficult because the rotary lawn mower blade is supported below a cowling and typically has an engine mounted on top of the cowling making access to the blade difficult. Access is typically obtained by placing the lawn mower on blocks or on elevated jacks or tilting the lawn mower to one side for access to the blade. This places the lawn mower in an awkward position for properly holding the blade in place while removing the retaining nut with a socket wrench. Access is even more difficult with heavy riding mowers which cannot be easily tilted or raised for access to the blade.

In the past, there have been a variety of patents dealing with tools for holding a rotatable lawn mower blade, such as shown in the Davidson U.S. Pat. No. 4,956,905 for a tool for holding a rotatable lawn mower blade which has a U-shaped bracket on the end of an elongated handle for placing over the blade and in the Kugler U.S. Pat. No. 4,882,960 for a lawn mower blade lock which locks the blade to the side of the cowling in a manner that the blade holder can also be used to lift and tilt a small lawn mower. The Taylor U.S. Pat. No. 4,564,991 is a tool for holding a blade for installation and removal thereof. Other tools for working on lawn mower blades can be seen in the Greenquist U.S. Pat. No. 4,736,544, for a blade holder for sharpening lawn mower blades in which the blade is sharpened while still attached to the mower and in the Wanie U.S. Pat. No. 5,865,018 for a cutter blade removal tool which slips onto the end of the blade and protrudes into the discharge chute of the cowling.

The present invention is an improvement to the prior lawn mower blade removal tools and simplifies and improves the holding of the blade during the removal of a rotary lawn mower blade from a lawn mower.

### SUMMARY OF THE INVENTION

The tool apparatus for holding a lawn mower blade for installation and removal of the blade has an elongated lever arm having a handle on the end thereof. A gripping portion is formed on the other end of the elongated lever arm blade engaging yoke formed thereon with a pair of spaced arms having a space therebetween. Each yoke arm has a blade engaging member extending perpendicular therefrom and each blade engaging member has a lip on the end thereof for engaging one side of the lawn mower blade over the lawn mower blade attaching nut. Each gripping portion has a third blade engaging member extending perpendicular therefrom and spaced from the pair of blade engaging members for engaging the other side of the lawn mower blade so that a lawn mower blade can be held by the tool over the lawn mower blade attaching nut for removing the attaching nut with a wrench.

### BRIEF DESCRIPTION OF THE DRAWINGS

Other objects, features, and advantages of the present invention will be apparent from the written description and the drawings in which:

FIG. 1 is a perspective view of the lawn mower blade removal tool in accordance with the present invention attached to a lawn mower blade;

FIG. 2 is a perspective view of the lawn mower tool of FIG. 1; and

FIG. 3 is a side elevation of the lawn mower tool of FIGS. 1 and 2.

### DESCRIPTION OF THE PREFERRED EMBODIMENT

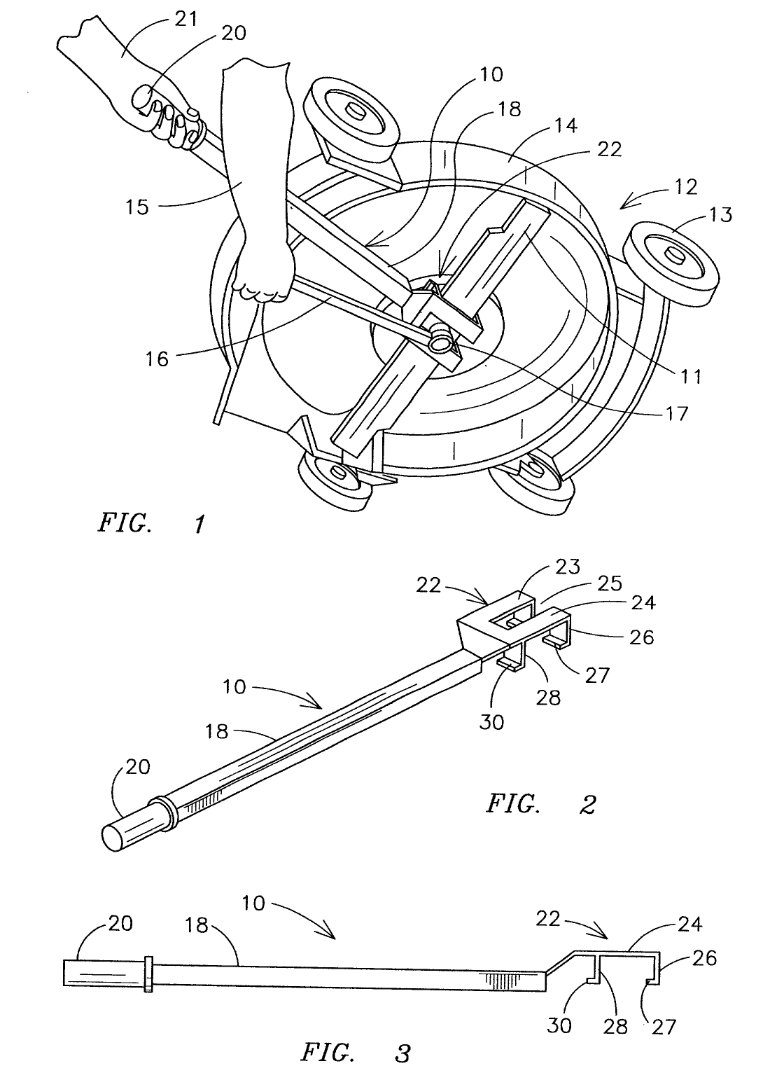

Referring to the drawings, FIGS. 1 through 3, a hand tool 10 for holding a lawn mower blade 11 attached to a lawn mower 12 is illustrated attached to the lawn mower blade 11. The lawn mower 12 having wheels 13 and a cowling 14 is shown in a tilted position having the tool 10 attached to a nut or bolt attaching the blade 11 to a lawn mower engine shaft holding the blade 11 in place while a person 15 is using a socket wrench 16 having a socket 17 on the end thereof to remove the nut for removing the blade 11. The lawn mower removal tool 10 has a lever arm 18 having a handle 20 on the end thereof held by a person's hand 21. The tool 10 has a blade holding portion 22 formed with a U-shaped yoke having two arms 23 and 24 leaving an open yoke portion 25 for sliding over a blade and around the blade removal nut, as seen in FIG. 1. Each arm 23 and 24 has a perpendicularly extending blade gripping portion 26 having a turned-in lip 27 forming a generally L-shape for gripping around the blade with the lip 27 extending under the blade. A separate perpendicularly blade gripping portion 28 extends perpendicular from each arm 23 and 24 and also has a lip 30, similar to the lip 27, extending therefrom. The blade gripping portion 28 supports one side of the blade while the blade holding portion 27 holds the other side of the blade.

In operation, the blade holding portion 22 is slipped over a blade, as shown in FIG. 1, with the blade gripping portion 26 on one side of the blade and the lip 27 extending beneath the blade. The rear blade arm 28 extends adjacent the other side of the blade. Once the blade holding tool 10 is connected to the blade 11, as shown in FIG. 1, and supported by a man's hand 21, the wrench 16 with the socket over the removal bolt is loosened to remove the blade holding bolt to remove the blade. The elongated lever 18 as well as the entire tool 10 can be made of steel.

It should be clear at this time that a blade holding tool which is easy to manufacture and utilize has been provided which advantageously extends over the lawn mower blade securing nut or bolt for securing the blade to the drive shaft. However, this invention is not to be construed as limited to the forms shown which are to be considered illustrative rather than restrictive.

I claim:

1. A tool for holding a lawn mower blade for installation and removal thereof comprising:
an elongated lever arm having a handle on one end thereof and a blade gripping portion on the other end thereof, said blade gripping portion having a blade engaging yoke formed with a pair of spaced arms having a space therebetween, each arm having a blade engaging member extending perpendicular therefrom and each blade engaging member having a lip on the end thereof for engaging one side of a lawn mower blade over the lawn mower blade attaching nut and said blade gripping portion having a third blade engaging member extending perpendicular therefrom and spaced from said pair of blade engaging members for engaging the other side of said lawn mower blade whereby a lawn mower blade can be held by said tool over the lawn mower blade attaching nut and the attaching nut removed with a wrench.

2. The tool for holding a lawn mower blade in accordance with claim 1 in which said third blade engaging member has a lip thereon.

3. The tool for holding a lawn mower blade in accordance with claim 2 in which said third blade engaging member lip extends away from said blade.

4. The tool for holding a lawn mower blade in accordance with claim 3 in which said blade gripping portion is offset from said lever.

5. The tool for holding a lawn mower blade in accordance with claim 4 in which said pair of blade engaging members and said third blade engaging member are parallel to each other.

6. The tool for holding a lawn mower blade in accordance with claim 5 in which said pair of blade engaging members and said third blade engaging member lips extend toward said tool handle.

7. The tool for holding a lawn mower blade in accordance with claim 2 in which said elongated lever arm is made of steel.
